(19) United States
(12) Patent Application Publication
(10) Pub. No.: US 2026/0249332 A1
(43) Pub. Date: Aug. 27, 2026

(54) MACHINE FOR REMOVING SEDIMENT, DREGS, AND THE LIKE

(71) Applicant: GEROTTO FEDERICO S.R.L., CAMPODARSEGO (PADOVA) (IT)

(72) Inventors: Roberto GEROTTO, CAMPODARSEGO (PADOVA) (IT); Alessandro GEROTTO, CAMPODARSEGO (PADOVA) (IT); Alberto FELETTO, GAIARINE (TREVISO) (IT)

(73) Assignee: GEROTTO FEDERICO S.R.L., CAMPODARSEGO (PADOVA) (IT)

(21) Appl. No.: 19/163,213

(22) PCT Filed: Dec. 20, 2023
(86) PCT No.: PCT/EP2023/087105

§ 371 Date: Sep. 8, 2025

(30) Foreign Application Priority Data
Mar. 10, 2023 (IT) 102023000004494

(51) Int. Cl. B08B 9/087; B08B 9/093; B08B 9/46

(52) U.S. Cl. CPC B08B 9/087; B08B 9/0933; B08B 9/46; B08B 2209/08

(57) ABSTRACT

A machine for removing sediment, dregs, and the like, comprising a self-propelled machine body provided with a pumping unit having a suction duct of material to be removed and a delivery duct of the removed material; the machine comprises a supply device of the material to be removed, movably connected to the machine body and adjustably positionable with respect to a supporting plane of the machine; the supply device (20) moves between an operational configuration, in which it is supported on the support plane (P) of the machine, and a non-operational configuration, in which it is lifted from the support plane. The supply device has an oscillating tool, selectively activated in rotation with reciprocating motion in order to dislodge the material to be removed and convey the material to a suction mouth that is fluidically connected to the suction duct.

The present invention refers to a machine for removing sediment, dregs, and the like. The machine is particularly adapted to perform cleaning and restoration operations in tanks and cisterns used for storing petroleum products and/or chemical products.

As known, fluid storage tanks used in the oil industry and in the chemical industry are periodically subjected to cleaning operations.

In fact, inside such fluid storage containers, an accumulation of mud tends to occur near or at the bottom, as a result of the slow sedimentation of products with high gravity.

This can give rise to a variety of problems, including, for example, a reduction in container capacity, the onset of corrosion phenomena, and others.

In this regard, various systems are therefore used to carry out the necessary cleaning operations.

Among them, so-called ‘no-man-entry’ technologies are becoming increasingly popular, whereby the necessary operations are carried out without the assistance of operating personnel inside the storage containers.

No-man-entry technologies for cleaning tanks and cisterns with white oil and black oil are relatively recent and, together with systems using robotic systems, offer an alternative to traditional cleaning methods, that involved personnel entering the tanks and removing sediment and sludge, or other technologies involving the use of automated recirculation systems for sludge dissolution, suction and separation of solid materials from hydrocarbons.

The robotic systems currently available basically involve the use of a special robotic machine designed to enter the fluid storage container, an external control unit, an external power unit, and an external suction unit, such as for example a centralized vacuum cleaner or a purge truck.

It should be noted that a self-purge system involves a pneumatic conveyance of the material that is dragged through the pipe by the speed of air until the maximum vacuum limit of 0.8 bar is reached; with viscous fluids, the material tends to stick and stop in the pipe.

In practice, the vacuum technology needs to transform the mud into liquid in order to enable its transfer thus creating evident problems of waste generation.

Alternatively, it is possible to install a positive displacement pump on board the robotized machine; this type of pump allows the mud to be transferred as it is, but its air suction capacity is considerably lower and therefore it is necessary to supply the material to its suction mouth.

It must also be considered that those machines must operate in areas with high explosion risk and must be controlled from the outside via an umbilical system, formed by long, heavy pipes.

Therefore, increasing the number of hydraulic actuators on the machine, results in increasing the size and weight of the umbilical system, with the risk of making it too heavy for the machine to be able to move.

Another aspect to consider is that these machines operate in environments with a high layer of oily sludge, sometimes equal to the height of the machine itself; therefore, any device must be extremely robust or the machine itself will not function.

EP3560613A1, in the name of this same applicant, discloses a suction device for the removal of muddy and/or viscous sediment stratified on the bottom of storage tanks.

JP2003154324A discloses an apparatus for removing sludge in the tank equipped with a sludge recovery part having stirring blades or waste sludge plates driven by compressed air to collect sludge deposited on the bottom part of the tank; a support part for supporting the sludge recovery part in an up and down movable manner; crawler parts on which the support part is placed and the hose housing part placed on the crawler parts and taking up the air supply hose of compressed air to house the same.

CN206570856U discloses a desilting machine used for drainage pipeline networks, river course open channel desilting, including a bucket assembly, a work arm amplitude changing device, a video assembly, a control cavity assembly, an impeller pump subassembly, a track assembly, a ground control system.

U.S. Pat. No. 11,571,723B1 discloses a mechanical dry waste excavating end effector for cleaning contaminated tanks without introducing large amounts of free water or liquefier into the tanks. A gathering arm assembly and a bucket assembly is used to remove and break up waste debris from a contaminated tank.

JPH06142626A discloses a sludge eliminating device in tank. The device has a carriage running on the bottom face, a cover, which is attached to the front part of the carriage and whose front and lower part are opened, an impeller which is supported so as to be rotatable in the inside of the cover and scrapes off sludge, and a treating liquid supply hose for supplying a treating liquid for melting the sludge to a blade through a hollow axle of the impeller. The device also has a molten sludge suction tube which is attached to the carriage, whose tip part is positioned in the rear of the impeller, and which has a bell-mouth in its tip part, a pump loaded on the carriage for connecting the suction tube to a suction port, and a molten sludge discharge tube connected to a discharge port of the pump.

JPH10118598A discloses a collecting robot, for scavenging sludge in tank storing petroleum or the like, having soil-discharging plates of hydraulic driving opening and closing oscillating type in which three pieces of soil-discharging plates can be formed to U-shape or T-shape and can oscillate up and down. At a rear side of the travelling part, the robot is provided with a scraper which can move up and down via a hydraulic driving link mechanism.

RU2616051C1 discloses an apparatus for cleaning tanks comprising a volume pump with a washing liquid supply tank connected with a flexible hose to spray devices and arranged on a trolley made as a movable articulated frame structure fixed to a suction pipe, with a hydraulic valve and a diffuser. On the suction pipe there is a platform for control equipment fixing on it which is made in the form of adjustable and nonadjustable throttles and spool valves. A flexible conduit is connected to the suction pipe from the vacuum unit. A hydraulic drive, with a volume pump and a tank for working fluid, is connected, with flexible hoses and through the control equipment, to the hydraulic motors mounted on the wheel set frames and tracks connected to the driving wheels, the hydraulic cylinder of the wheel decouplement (rollup) and to the hydraulic cylinder of the rod in the vertical plane. The apparatus allows to exclude the presence of people inside the reservoir during the stripping process.

The aim of the present invention is to provide a machine for removing sediment, dregs and the like, that overcomes the drawbacks of the cited prior art.

Within the above aim, a particular object of the invention is to provide a machine that allows the material to be removed to be continuously conveyed to the suction pump by means of a relatively simple solution, involving few hydraulically-driven movements.

A further object of the invention is to provide a robust machine that minimizes the risk of damage, in particular avoiding damage to the hydraulic circuit.

A further object of the invention is to provide a machine that is self-cleaning and able to unclog the suction pipe independently, avoiding in this way costly machine downtime.

A further object of the invention is to provide a machine that is compact enough to enter a tank through a manhole.

A further object of the invention is to provide a machine that can operate even in the presence of explosive atmospheres.

This aim, these objects and others which will become better apparent hereinafter are achieved by a machine for removing sediment, dregs, and the like, as claimed in the appended claims.

Further characteristics and advantages will become better apparent from the description of a preferred, but not exclusive, embodiment of a machine according to the invention, illustrated by way of non-limiting example in the accompanying drawings wherein:

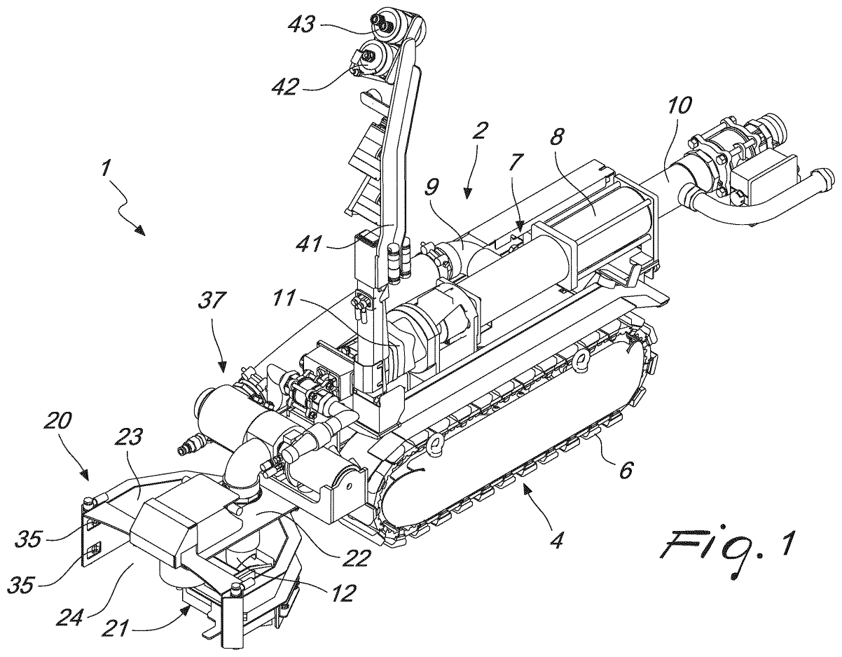

FIG. 1 is a perspective view of the machine according to the invention;

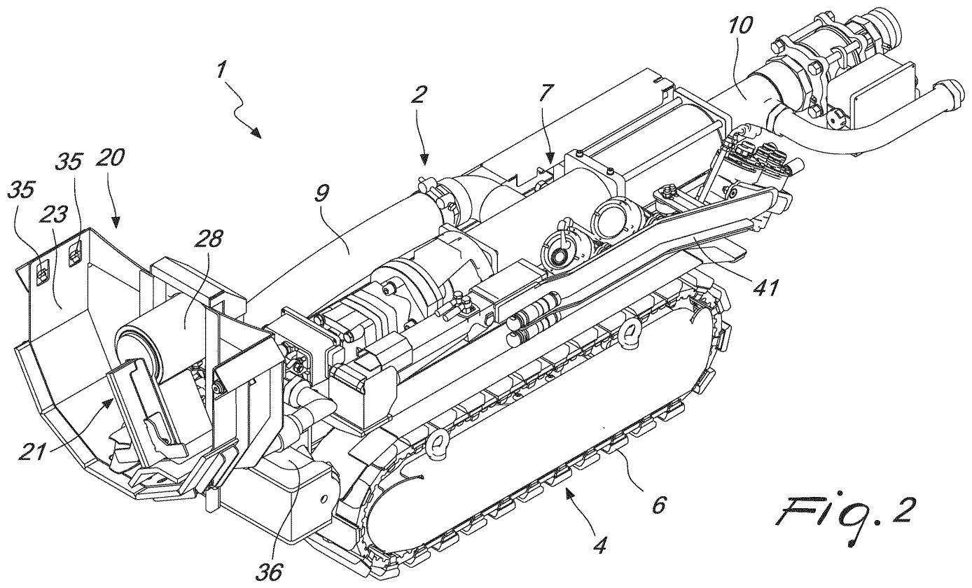

FIG. 2 is another perspective view of the machine according to the invention;

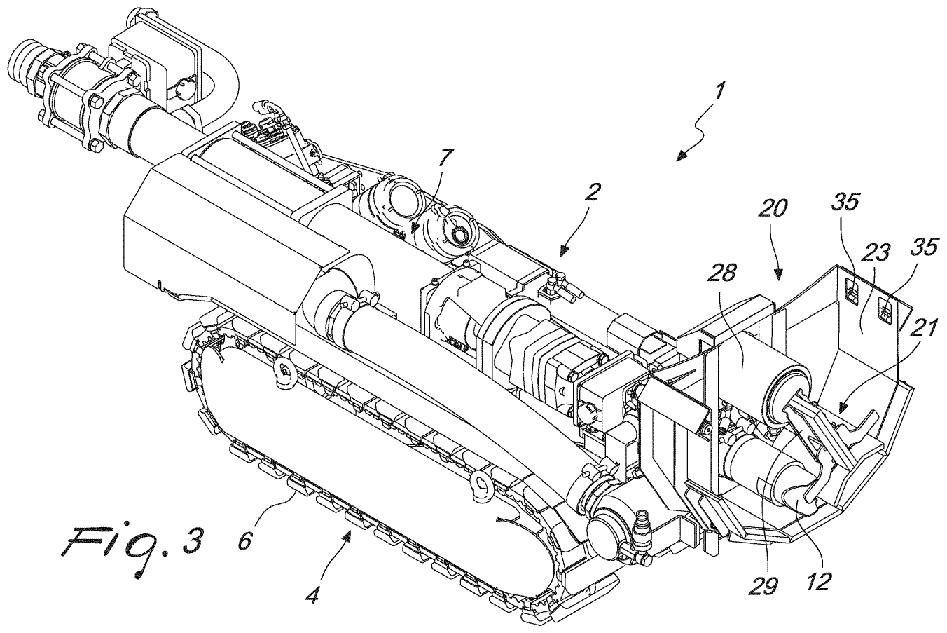

FIG. 3 is another perspective view of the machine according to the invention;

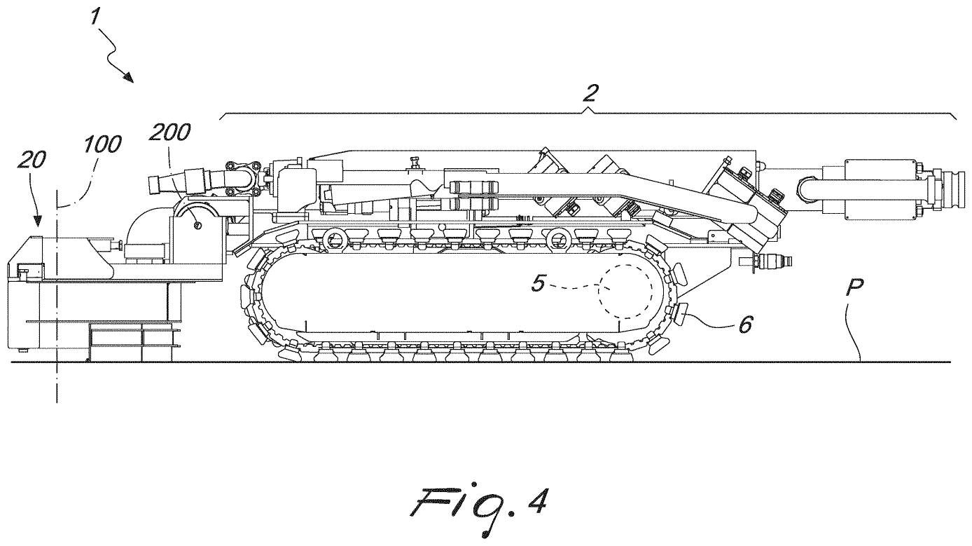

FIG. 4 is a side view of the machine according to the invention, in an operational condition;

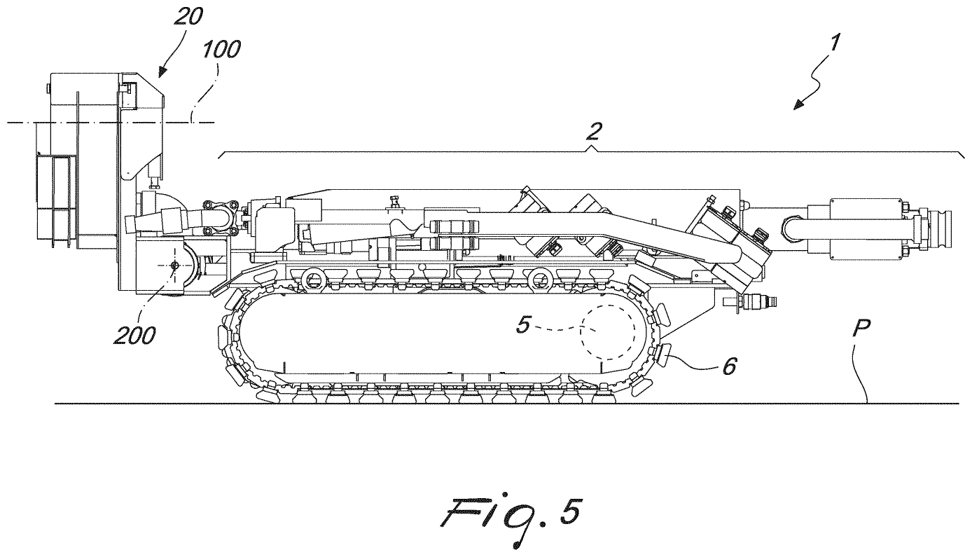

FIG. 5 is a side view of the machine according to the invention, in a non-operational condition;

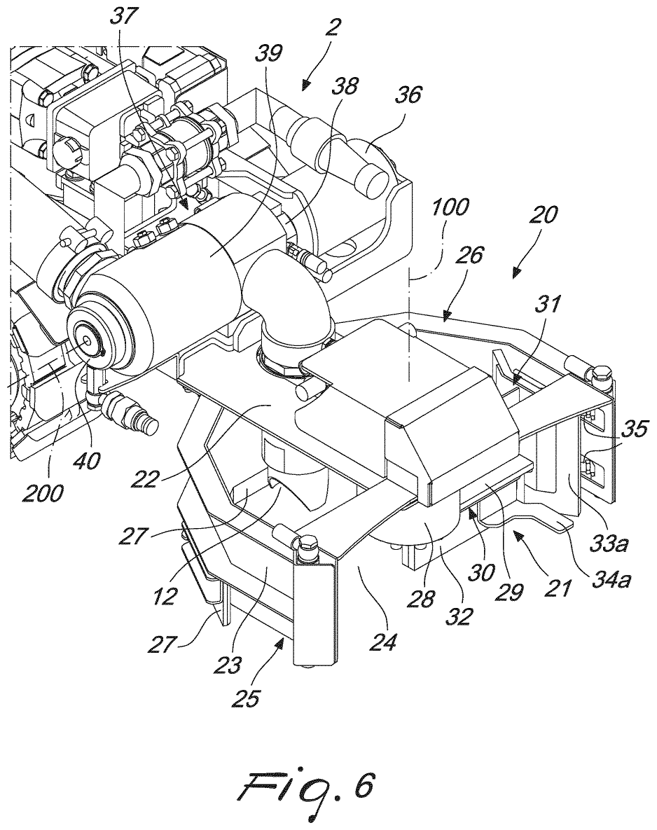

FIG. 6 is a perspective view illustrating the front portion of the machine in greater detail;

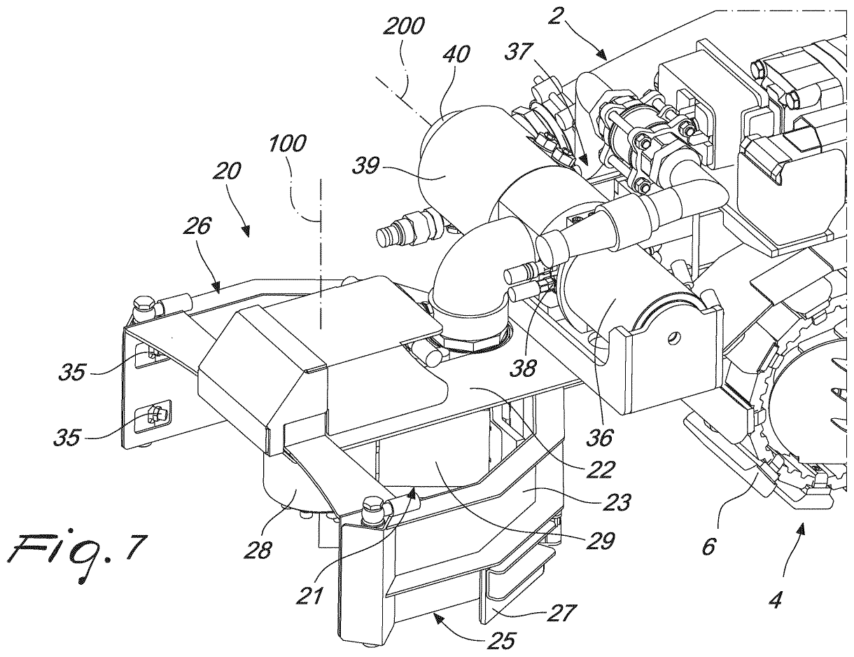

FIG. 7 is another perspective view illustrating the front portion of the machine in greater detail;

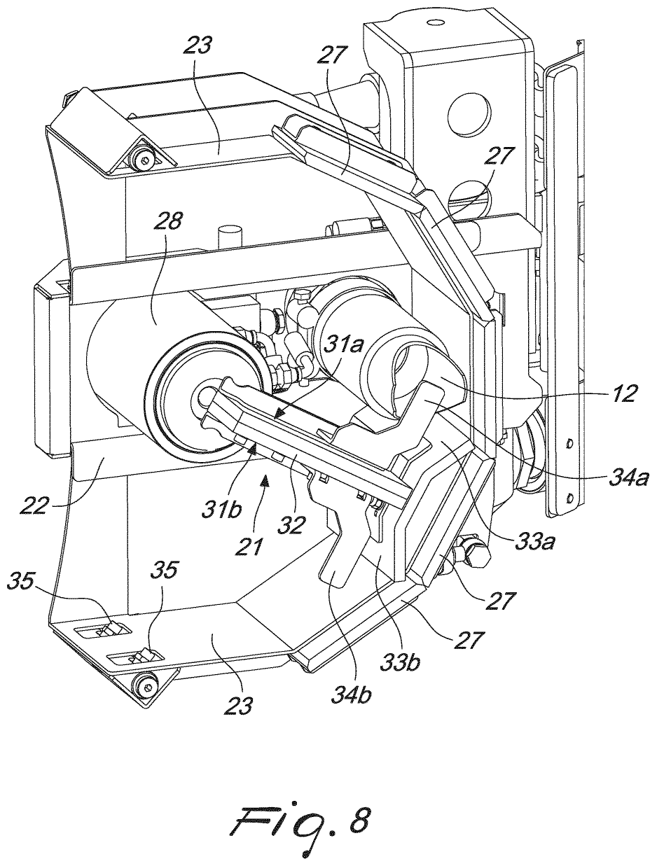

FIG. 8 is a perspective view illustrating a machine component in greater detail;

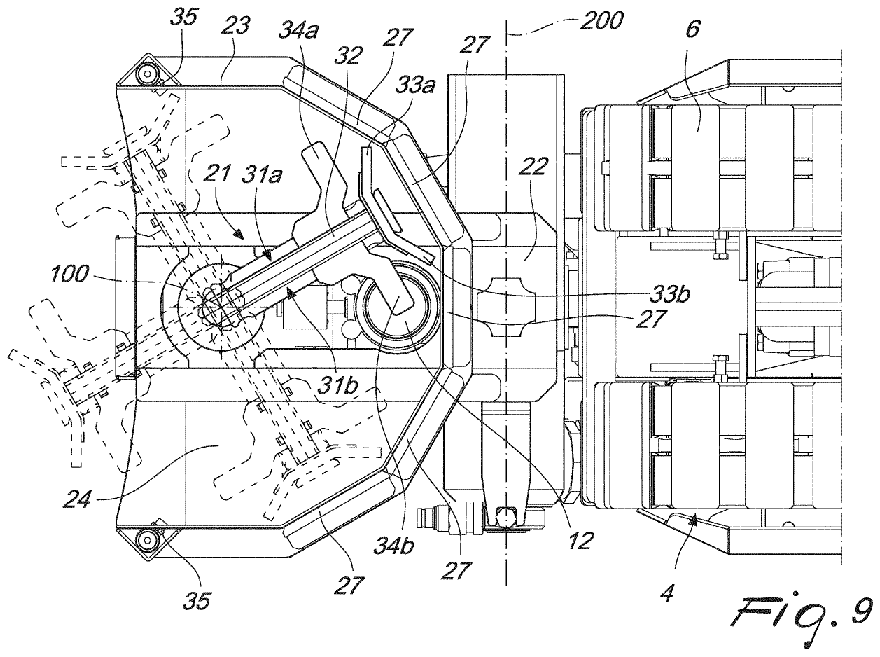

FIG. 9 is a view from below illustrating the front portion of the machine in greater detail.

With reference to the figures, a machine for removing sediment, dregs, and the like, is generally indicated by the reference numeral 1.

The machine 1 is particularly designed to perform cleaning operations in confined spaces, such as tanks and cisterns for the storage of petroleum products, without the assistance of operating personnel inside them, thus constituting a de facto a no-man entry technology.

For this purpose, the machine 1 is fully remote-controlled and controlled by means of an umbilical system, not illustrated, consisting of a bundle of connections providing both the fluidic and electrical power supply, and the commands to actuate the various functions and sensors installed on the machine 1.

In addition, the machine 1 is substantially designed to operate in environments at risk of explosion.

It will be apparent to the person skilled in the art that the machine 1 is also suitable for uses other than those indicated above, without thereby falling outside the scope of protection of this patent.

The machine 1 has a machine body 2 comprising a frame 3 having a handling means 4 allowing the machine 1 to move above a supporting plane P consisting, for example, of a bottom area of a tank or of a cistern.

In the case illustrated, the handling means 4 comprises a pair of fluidic motors 5 actuating a respective pair of tracks 6, preferably of the magnetic type, positioned on opposite sides of the machine body 2.

A pumping unit 7 is mounted on the frame 3 and is designed to vacuum material to be removed that has been deposited on the supporting plane P.

This material may be in solid, liquid or semi-solid form, and may consist, for example, of oily dregs formed from solid particles, crude oil and water.

The pumping unit 7 is a positive displacement pump 8, preferably a progressive cavity pump, which is equipped with a suction line 9 of the material to be removed and a delivery duct 10 of the removed material.

The positive displacement pump 8 is driven by a fluidic motor 11.

The delivery duct 10 is located at the rear of the machine body 2 and is adapted to connect the pumping unit 7 with a storage point of the removed material, located in a remote position with respect to the machine 1.

Preferably, the transfer of material from the machine 1 to the remote storage point occurs through a flexible pipe, not shown, that is integrated into the umbilical.

According to the present invention, the machine 1 comprises a supply device 20 of the material to be removed; the supply device 20 is movably connected to a front part of the machine body 2 and can be positioned in an adjustable manner with respect to the supporting plane P.

In particular, the supply device 20 moves at least between an operational configuration, in which it is substantially supported on the support surface P, as illustrated by way of example in FIG. 4, and a non-operational configuration, in which it is lifted from the support surface P, as illustrated by way of example in FIG. 5.

The supply device 20 is equipped with an oscillating tool 21 that can be selectively activated in rotation with reciprocating motion around a first axis of rotation 100, as illustrated in FIG. 9.

Advantageously, the oscillating tool 21 can be controlled to automatically rotate between two extreme positions defined by an oscillation angle preferably comprised between 0° and 300°, or it can be rotated in both directions, clockwise and counter-clockwise, at the discretion of an operator and in compliance with any detailed requirements.

The oscillating tool 21 operates to dislodge the material to be removed and convey it to a suction mouth 12 connected to the suction duct 9.

Preferably, the suction mouth 12 is at least partially made of a substantially flexible material, such as rubber or the like.

The supply device 20 comprises a supporting structure 22, which has a side wall 23 at least partially made of a substantially stiff material, such as metal.

The side wall 23 forms a storage space 24 for the material to be removed.

For this purpose, the side wall 23 is substantially shaped as an arc of a circle of amplitude of about 180° centered on an extension axis substantially parallel and close to, preferably coincident with, the first axis of rotation 100. The side wall 23 extends along such axis between a lower end 25 and an upper end 26.

In the illustrated embodiment, the side wall 23 has a polygonal profile in cross-section; however, it will be apparent to the person skilled in the art that, according to a further embodiment, not illustrated, the side wall may have different construction features, such as, for example, a curvilinear or mixtilinear profile in cross-section.

Advantageously, one or more scraper elements 27, at least partially made of substantially flexible material, such as rubber or the like, are removably mounted at the lower end 25 of the side wall 23.

The scraper elements 27 are configured to smoothly engage the supporting plane P when the machine 1 is in an operational condition, as described below.

The oscillating tool 21 is housed inside the containment place 24 and is rotated by a first handling device 28, consisting of a hydraulic actuator, for example.

The first handling device 28 is supported by the supporting structure 22 and enables the oscillating tool 21 to be rotated around the first rotation axis 100, as described above.

The oscillating tool 21 comprises a shovel portion 29, at least partially made of substantially stiff material such as metal for example, extending radially from the first axis of rotation 100 towards the side wall 23 and extending along that axis between a lower edge 30 and an upper edge 31.

Advantageously, the shovel portion 29 forms two thrust surfaces 31a and 31b, substantially parallel and opposite to each other, acting on the material to be removed.

The lower edge 30 of the shovel portion 29 and the lower end 25 of the side wall 23 are substantially arranged on the same plane which is transverse, preferably substantially orthogonal, to the first axis of rotation 100.

A scraper lip 32 is at least partially made of substantially flexible material, such as rubber or the like, and is removably mounted at the lower edge 30 of the shovel portion 29.

The scraper lip 32 is adapted to smoothly engage the supporting plane P when the machine 1 is in the operational condition mentioned above.

Two scraping tabs 33a and 33b extend transversely from the free side of the shovel portion 29, substantially parallel to the first axis of rotation 100. The two scraping tabs 33a and 33b extend from the thrust surfaces 31a and 31b towards the side wall 23.

The scraper tabs 33a and 33b are at least partially made of a substantially flexible material, such as rubber or the like.

Two opposing blades 34a and 34b protrude transversally from the lower edge 30 of the shovel portion 29, and are at least partially made of substantially stiff material, such as metal.

The shape and dimensions of the two blades 34a and 34b are chosen in such a way that they can alternately enter in the suction mouth 12 in order to free it from any foreign bodies that may clog it.

One or more nozzles 35 are arranged at each of the free sides of the side wall 23 substantially parallel to the first axis of rotation 100. In the illustrated embodiment, there are two nozzles 35 arranged at each side. The nozzles 35 are adapted to spray a treatment fluid, preferably consisting of water and/or a hydrocarbon-based solvent, towards the suction mouth 12.

The nozzles 35 dispense a blade of high-pressure treatment fluid that on the one hand scours and disintegrates the material to be removed and on the other hand keeps the oscillating tool 21 clean.

Advantageously, the supply device 20 is fastened to the frame 3 in order to oscillate about a second axis of rotation 200 which is transverse, more preferably substantially orthogonal, to the first axis of rotation 100.

A second handling device 36, consisting of, for example, an hydraulic actuator, is configured to move the supply device 20 between at least the operational configuration, illustrated in FIG. 4, and the non-operational configuration, illustrated in FIG. 5.

The distance of the supply device 20 from the supporting plane P is the minimum compatible with the operational movements of its sliding parts on the supporting surface P.

In the illustrated embodiment, when the supply device 20 is in the operational configuration the first axis of rotation 100 is substantially orthogonal to the supporting plane P, while in the non-operational configuration the first axis of rotation 100 is transverse or substantially parallel to the supporting plane P.

For example, the supply device 20 is brought into the non-operational condition when the machine 1 must overcome differences in level of any kind, for example to enter/exit the manhole of a tank, or more generally when it must be moved.

In practice, when switching from the operational to the non-operational configuration, the supply device 20 makes a rotation of approximately 90° around the second axis of rotation 200.

Accordingly, suitable rotating junction means 37 fluidically connect the supply device 20 to the machine body 2.

Advantageously, the axis of rotation of the rotating junction means 37 is substantially parallel and adjacent to, preferably coincident with, the second axis of rotation 200.

In the illustrated embodiment, the rotating junction means 37 comprise a first rotating joint 38, a second rotating joint 39 and a third rotating joint 40, with their respective axes of rotation substantially coinciding.

In this way, it is possible to avoid the presence of flexible movable pipes between the supply device 20 and the machine body 2, because all fluids pass through compulsory paths defined by the rotating junction means 37.

The first rotating joint 38 is configured to fluidically connect the first handling device 28 to operating fluid supply means, not shown.

The second rotating joint 39 is configured to fluidically connect the suction mouth 12 to the suction duct 9.

The third rotating joint 40 is configured to fluidically connect the nozzles 35 to treatment fluid supply means, not shown.

Advantageously, a lifting arm 41 is also mounted on the machine 1. The lifting arm 41 is hinged to the machine body 2 and is equipped with visual acquisition means, such as for example a video camera 42 and at least one lighting device 43, configured to detect images from above of the environment surrounding the operating/moving area of the machine 1.

The operation of machine 1 according to the present invention is apparent from the foregoing and is briefly described below.

The machine 1, which is initially in the non-operational condition, i.e. with the supply device 20 lifted in relation to the supporting plane P, is introduced through a manhole into a confined space, such as a tank, in which the material to be removed is deposited.

At this point, by means of a control panel placed outside the tank and connected by means of the umbilical to the machine 1, the operator places the lifting arm 41 transversally to the supporting surface P and puts the machine 1 into the operational condition, i.e., makes the supply device 20 rotate about 90° around the second rotation axis 200, substantially supporting it on the supporting plane P.

At this point the machine 1 is substantially ready to operate.

The oscillating tool 21 is then rotated around the first axis of rotation 100, as described above.

In practice, the operator decides whether to rotate the oscillating tool 21 automatically between two extreme positions defined by an oscillation angle preferably between 0° and 300°, or whether to rotate it in both directions, clockwise and counter-clockwise, at his or her discretion and in compliance with any detailed requirements.

As it moves, the oscillating tool 21 breaks up the material to be removed, assisted in this function by the nozzles 35, and conveys it towards the suction mouth 12 connected to the suction duct 9.

The material dislodged by the oscillating tool 21 is then sucked up by the volumetric pump 8 and continuously pumped to a storage point for the removed material, located in a remote position with respect to the machine 1, or in any case outside the tank.

By virtue of the on-board volumetric pump 8, the machine 1 is able to pump the removed material even over long distances.

Once the cleaning operations have been completed, the lifting arm 41 is placed in a position substantially parallel to the supporting plane P and the supply device 20 is placed in a non-operational condition, after which the machine 1 is removed from the tank.

In practice, it has been found that the invention achieves the set aim and objects with a machine capable of best reconciling multiple requirements.

In particular, in the machine according to the invention, the material to be removed is continuously conveyed to the suction pump by means of the supply device, which by means of the oscillating tool alone succeeds in efficiently supplying the pump.

The oscillating tool is also able to unclog the suction pipe independently, avoiding in this way costly machine downtime.

A further advantage of the invention is that the rotating joint interposed between the supply device and the machine body effectively eliminates all flexible ‘flying’ pipes; contrary to prior art machinery, this significantly reduces the risk of breakage.

The machine according to the invention is compact enough to fit into a tank through a manhole, and is also suitable for operation in the presence of explosive atmospheres.

This application claims the priority of Italian Patent Application No. 102023000004494, filed on Mar. 10, 2023, the subject matter of which is incorporated herein by reference.

We claim:

1. A machine for removing sediment, dregs, and the like, comprising a self-propelled machine body (2) provided with at least one pumping unit (7) having at least one suction duct (9) of a material to be removed, and at least one delivery duct (10) of the removed material;
said machine being characterized in that it comprises a supply device (20) of the material to be removed; said supply device (20) being movably connected to said machine body (2) and adjustably positioned with respect to a supporting plane (P) of said machine; said supply device (20) moving at least between an operational configuration, in which it is substantially supported on said support plane (P) of the machine, and a non-operational configuration, in which it is lifted from said support plane (P); said supply device (20) comprising at least one oscillating tool plane (21), selectively activated in rotation with reciprocating motion in order to dislodge the material to be removed and convey it to a suction mouth (12) that is fluidically connected to said suction duct (9).

2. The machine according to claim 1, wherein said supply device (20) comprises a supporting structure (22) having at least one substantially concave side wall (23), which is at least partially made of a substantially stiff material; said side wall (23) extending around an extension axis and extending along said extension axis between a lower end (25) and an upper end (26) forming a space (24) for containing the material to be removed; said oscillating tool (21) being housed within said space (24) and being actuated in rotation by a first handling device (28) moving with reciprocating motion around a first axis of rotation (100) substantially parallel and adjacent to the axis of extension of said side wall (23);
said oscillating tool (21) and said first handling device (28) being supported by said supporting structure (22).

3. The machine according to claim 1, wherein said side wall (23) comprises one or more scraper elements

(27) that are at least partially made of substantially flexible material; said scraper elements (27) being associated with the lower end (25) of said side wall (23).

4. The machine according to claim 1, wherein said oscillating tool (21) comprises a shovel portion (29) that is at least partially made of substantially stiff material; said shovel portion (29) extending radially from said first axis of rotation (100) towards said side wall (23) and extending along said first axis of rotation (100) between a lower edge (30) and an upper edge (31), forming two thrust surfaces (31a, 31b) of the material to be removed; said thrust surfaces (31a, 31b) being substantially parallel and opposite to each other; said lower edge (30) of said portion and the lower end (25) of said side wall (23) being substantially arranged on a same imaginary plane that is transverse to said first axis of rotation (100).

5. The machine according to claim 1, wherein said oscillating tool (21) comprises two scraper tabs (33a, 33b) that are at least partially made of substantially flexible material; said scraper tabs (33a, 33b) extending transversely from said thrust surfaces (31a, 31b) towards said side wall (23).

6. The machine according to claim 1, wherein said oscillating tool (21) comprises a scraper lip (32) that is at least partially made of substantially flexible material; said scraper lip (32) being associated with the lower edge (30) of said shovel portion (29).

7. The machine according to claim 1, wherein said oscillating tool (21) comprises at least one blade (34a, 34b) that is at least partially made of substantially stiff material; said blade (34a, 34b) extending transversely from the lower edge (30) of said shovel portion (29).

8. The machine according to claim 1, wherein said supply device (20) comprises a plurality of nozzles (35) housed inside said space said nozzles (35) being supplied with a treatment fluid and being oriented substantially towards said suction mouth (12).

9. The machine according to claim 1, further comprising a second handling device (36) for moving said supply device (20) between at least said operational configuration and said non-operational configuration.

10. The machine according to claim 1, wherein said supply device (20) is bound to said machine body (2) and oscillates about a second axis of rotation (200) transversal to said first axis of rotation (100);
in said operational configuration, said first axis of rotation (100) being substantially orthogonal to said supporting plane (P); in said non-operational configuration, said first axis of rotation (100) being transversal or substantially parallel to said supporting plane (P).

11. The machine according to claim 1, further comprising comprises a rotating junction means (37) configured to fluidically connect said supply device (20) to said machine body (2); the axis of rotation of said rotating junction means (37) being substantially parallel and adjacent to said second axis of rotation (200).

12. The machine according to claim 1, wherein that said rotating junction means (37) comprise a first rotating joint (38), a second rotating joint (39), and a third rotating joint (40), having respective axes of rotation substantially coinciding; said first rotating joint (38) being configured to fluidically connect said first handling device (28) to operating fluid supply means; said second rotating joint (39) being configured to fluidically connect said suction mouth (12) to said suction duct (9); said third rotating joint (40) being configured to fluidically connect said nozzles (35) to supply means for said treatment fluid.

13. The machine according to claim 1, further comprising a lifting arm (41) hinged to said machine body (2); said lifting arm (41) comprising visual acquisition means (42) configured to take images from above of the environment surrounding the operating/movement area of said machine.
